(19) United States
(12) Patent Application Publication
(10) Pub. No.: US 2006/0294131 A1
(43) Pub. Date: Dec. 28, 2006

(54) SYSTEM AND METHOD FOR GENERATING A PLAY-LIST

(76) Inventors: Kuan-Hong Hsieh, Shenzhen (CN); Zai-An Pan, Shenzhen (CN); Xiao-Guang Li, Shenzhen (CN); Bing Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,707

(22) Filed: Apr. 24, 2006

(30) Foreign Application Priority Data
Jun. 24, 2005 (CN) 200510035542.3

(51) Int. Cl. G06F 7/00

(52) U.S. Cl. 707/102

(57) ABSTRACT

The present invention relates to a method for generating a play-list of media files, includes the steps of: setting a weight field in the tag for storing a weighted value of the media file; receiving a control command in course of playing a media file; increasing the weighted value in the weight field of the media file if the control command is for replaying the media file; decreasing the weighted value in the weight field of the media file if the control command is for skipping the media file; receiving a control command being for generating a play-list; and generating the play-list of the media files according to the weighted values thereof in response to the control command. The present invention also provides a system for generating the play-list. The present invention makes the play-list more suitable to the user's favors.

### FIELD OF THE INVENTION

The present invention relates to a system and method for generating a media play-list, especially to a system and method for generating a play-list according to a replaying count and a skipping count of the media files.

### DESCRIPTION OF RELATED ART

The continuous development of new digital technology has helped made digital devices such as digital audio, digital picture, and other digital medias become popular among people. Media can be stored digitally in various data storage medium such as a hard disk, a compact disc (CD), and a network server. These data storage medium can then be used with portable devices such as a personal digital assistant (PDA), a media player, and/or an electronic-book reader (e-book). A current standard CD can store up to 140 average sized Moving Pictures Experts Group (MPEG) layer three (MP3) media files, whereas a media player with a data storage medium of 10 Gigabytes can store up to 2000 MP3 files. The cost of data storage medium has continued to decrease, allowing an average person to more easily acquire extra data storage capacity. Currently, a personal computer has a standard data storage capacity of 80 Gigabytes that can easily store up to 160,000 pieces of average sized MP3 files. As users continuously acquire their favorite media files, it is important that users can also quickly identify and select a desired media file from a humongous pool of stored files.

Most media players currently have an option to group and select media files by the media file's tag contents. Usually, the media file's title, artist, album, and genres identity are stored by the tags to allow media players to automatically search and categorize the files. A media file management program further allows users to select a combination of media files into a play-list file. The saved play-list is essentially a list of shortcuts (pointer to the directory path) of the media files stored within, and can be used by the media player instead of manually searching and selecting every desired media files each time the media player is executed. Each play-list can then be categorically stored by name. However, users are still required to remember the directory path where each play-list is stored. As a user creates more and more play-lists, remembering a desired play-list may not be easy, furthermore, skipping over an unwanted media file while playing a play-list still has to be done manually.

In order to solve the problems mentioned, there is a method available in the market in selecting favorite media files to generate a play-list. For example, US patent application file No. 2003/0221541 published on Dec. 4, 2003 and entitled “AUTO PLAYLIST GENERATION WITH MULTIPLE SEED SONGS” provides a method for generating a play-list automatically. The method includes steps of: selecting one or more feed media files, the feed media files include desired media files and undesired media files; wherein the user can set a weight on each seed media file representing the importance level of each seed media file. Afterwards, the method compares each media file with each seed media file such that a media file can be analyzed and identified into a user defined preferred play-list. The play-list further allows manual edits by the user.

However, the above mentioned method requires manual inputs on the weight attributes on multiple seed files before the method can run comparison tests on each media files. These manual operations may be annoying and time consuming with no guarantee that the resulting selected media files would be a user's favorites.

Therefore, a heretofore unaddressed need exists in the industry to overcome the aforementioned deficiencies and inadequacies.

### SUMMARY OF INVENTION

In order to solve said problems, the present invention provides a method and system for updating a weighted value on each media file based on a replaying count or a skipping count of the media file; and then generating a play-list according to weighted values. The present invention makes the play-list more suitable to the user's favors.

The method for generating a play-list of media files, each of the media files includes a tag for holding basic information about the media files. The method includes the steps of: setting a weight field in the tag for storing a weighted value of the media file; receiving a control command in course of playing a media file; increasing the weighted value in the weight field of the media file by a first predetermined value if the control command is for replaying the media file; decreasing the weighted value in the weight field of the media file by a second predetermined value if the control command is for skipping the media file; receiving and responding to a control command being for generating a play-list; obtaining the weighted value in the weight field of each media file from the weight field thereof; and generating the play-list of the media files according to the weighted values thereof.

The system for generating a play-list of media files, each of the media files includes a tag for holding basic information about the media files. The system includes a data storage unit, an input unit, a control unit and a file management unit. The data storage unit stores the media files, wherein the tag of each media file includes a weight field for storing a weighted value of the media file. The input unit generates commands in response to operations of a user. The control unit identifies the commands and performing corresponding control commands, wherein the control commands comprises a play-list generation control command. The file management unit, under the control of the control unit, receives a control command in course of a media file being played, increases the weighted value in the weight field of the media file by a first predetermined value if the control command is for replaying the media file, decreases the weighted value in the weight field of the media file by a second predetermined value if the control command is for skipping the media file, receives the play-list generation control command, and generates the play-list of the media files according to the weighted values thereof in response to the play-list generation control command.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a schematic diagram of a user interface of a media player such as a MP3 player in accordance with a preferred embodiment of the present invention;

FIG. 2 is a block diagram hardware infrastructure of the media player of FIG. 1;

FIG. 3 is a flowchart of a preferred method for generating and playing a play-list in the media player of FIG. 2;

FIG. 4 is a flowchart of a preferred method for updating the weighted value in the weight field of a media file being played of FIG. 3; and

FIG. 5 is a schematic diagram representing a relationship between a weighted value and a total percentage of an actual played media before the media file is skipped.

### DETAILED DESCRIPTION

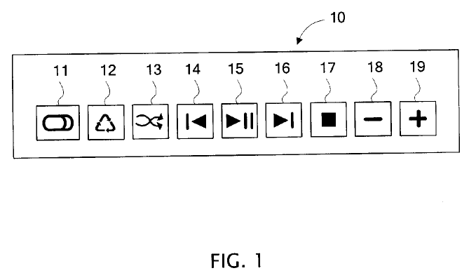

FIG. 1 is a schematic diagram of a user interface of a media player such as a MP3 player in accordance with a preferred embodiment of the present invention. The media player 10 is user-controllable to skip forward (e.g., to previous item), play a media file, pause a playing media file, skip backward (e.g., to next item), activate/deactivate the media player, adjust the volume output of the played media file, and the like. Accordingly, the media player 10 provides a user interface for selecting these functions. The user interface sets a plurality of buttons thereon, such as a skip forward button 14, a play/pause button 15, a skip backward button 16, a stop/power button 17, a decreasing volume button 18, and an increasing volume button 19. The user interface further sets a play in order button 12 for playing selected digital media files in a predefined sequential order, and a random play button 13 for playing randomly. Moreover, the user interface includes a lock button 11 for locking the buttons 12 to 19 thereby disabling the buttons therewith.

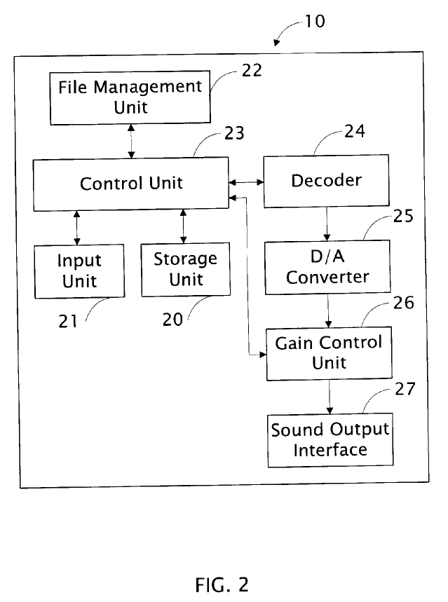

FIG. 2 is a block diagram hardware infrastructure of the media player of FIG. 1. The media player 10 includes a data storage unit 20, an input unit 21, a file management unit 22, a control unit 23, a decoder 24, a digital/analog converter 25, a gain control unit 26 and a sound output user interface 27. The data storage unit 20 stores a plurality of media files, a default play-list, and one or more favorite index tables for indicating favorite media files of a user. Each of the media files is composed of a plurality of frames; a frame can be viewed as a small segment of the media. Furthermore, each media file includes a tag for holding basic information of the media file. The basic information includes a weighted value, a frame length, and so on. Accordingly, the tag includes a weight field, a frame length field, and so on, for storing their corresponding information. The weighted values indicate the user's preference level on a given media file. In addition, the data storage unit 20 can be a flash storage, a hard disk driver, and the like.

The input unit 21 includes a plurality of buttons (i.e., 11 to 19), thereby forming the user interface of FIG. 1 to generate commands in response to operational inputs. The control unit 23 receives and identifies the commands from the input unit 21, and generates corresponding control commands to control the data storage unit 20, the file management unit 22, the gain control unit 26, and the like. Wherein, the control commands include a control command for generating a play-list, a replaying control command, and a skipping control command.

When a control command is issued by the control unit 23, the file management unit 22 obtains the weighted value in the weight field of each media file, stores the weighted value of each media file in a temporary file, generates a play-list of the media files according to the weighted values stored in the temporary file, stores the play-list in the data storage unit 20, plays the media files listed on the play-list, increases the weighted value in the weight field of the media file according to the replaying control command; and decreases the weighted value in the weight field of the media file according to the skipping control command. In addition, the media files listed on the play-list may be from media files stored in the data storage unit 20, or may be from favorite media files indicated in the index table stored in the data storage unit 20.

The decoder 24 decodes the media file from a coded digital format into a readable digital format to be played. The digital/analog converter 25 converts the decoded digital media file to analog media signals. The gain control unit 26 amplifies the analog media signals under the control of the control unit 23. The sound output interface 27 outputs the amplified analog media signals to an earphone or a speaker (not shown).

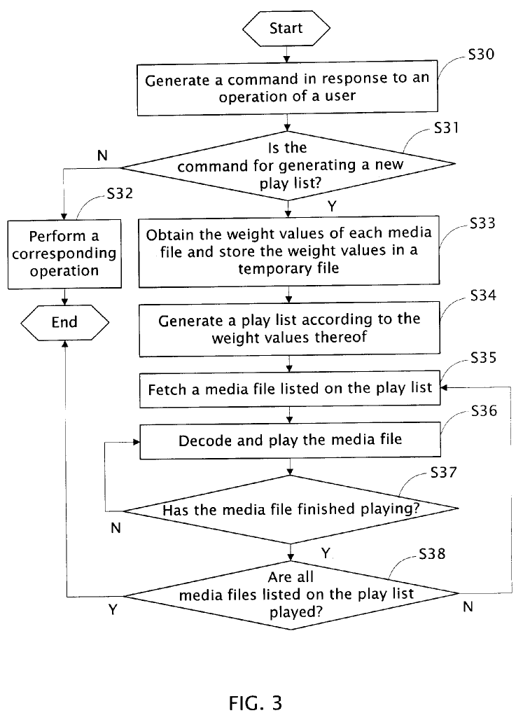

FIG. 3 is a flowchart of a preferred method for generating and playing a play-list in the media player of FIG. 2. In a power-off state of the medial player 10, a user selects the stop/power button 17 to activate the media player 10. In step S30, the input unit 21 generates a command in response to an input selection of the user, and sends the command to the control unit 23. In step S31, the control unit 23 determines whether an inputted command is for updating a default play-list, namely generating a new play-list. If the command is not for generating a new play-list, in step S32, the control unit 23 controls a corresponding unit to perform a corresponding operation according to the command, and the procedure is finished.

If the command is for generating a new play-list, in step S33, the control unit 23 controls the file management unit 22 to obtain the weighted values in the weight field of each media file, and stores the weighted values in a temporary file. In step S34, the file management unit 22 generates a play-list according to the weighted values thereof. For example, the file management unit 22 rearranges all the media files stored in the data storage unit 20 according to the weighted values, thereby generating a play-list therefrom. That is, the file management unit 22 orderly rearranges the media files according to the weighted values, or calls a random function, which employs the weighted values in the weight field of the media files as a parameter, to randomly rearrange the media files. With respect to the random function, the media files having the greater weighted values would be listed in the beginning portion of the play-list.

Furthermore, the file management unit 22 directly selects a plurality of media files each of which has a weighted value being greater than a predetermined value, thereby generating another play-list therefrom. In addition, the file management unit 22 rearranges all the media files based on the weighted values in descending order, and then selects a predetermined amount of media files on the top of the ordered list, thereby generating another play-list therefrom.

In step S35, the file management unit 22 fetchs a media file listed on the play-list. In step S36, the decoder 24 decodes the media file from a coded digital form to a decoded digital form, the digital/analog converter 25 converts the digital media signals to analog media signals, the gain control unit 26 amplifies the analog media signals under the control of the control unit 23, the sound output user interface 27 outputs the amplified analog media signals to an earphone or a speaker (not shown). In step S37, the file management unit 22 determines whether the media file has finished playing. If the media file has not finished playing, the procedure goes to step S36 to continually decode and play the media file. If the media file has finished playing, in step S38, the file management unit 22 determines whether all media files listed on the play-list are played. If all the media files listed on the play-list are played, the procedure is finished. If any media file listed on the play-list is not played, the procedure goes to step S35 to obtain a next media file listed on the play-list.

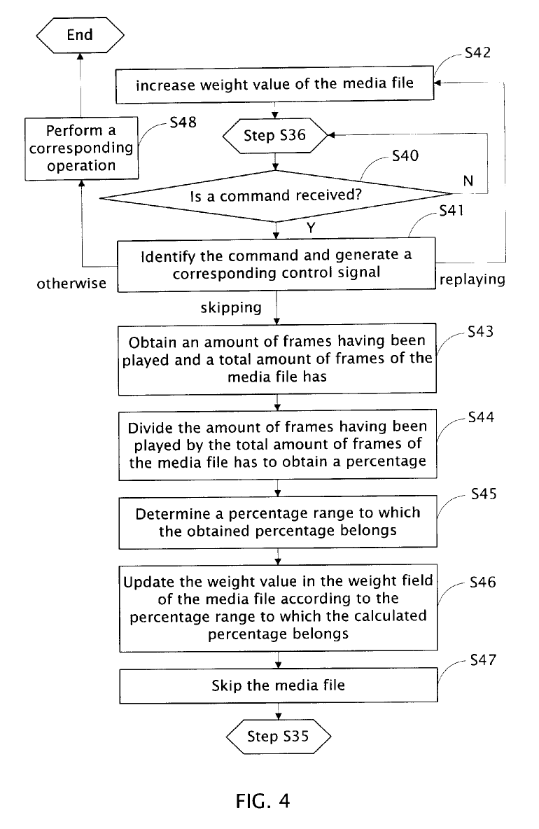

FIG. 4 is a flowchart of a preferred method for updating the weighted value in the weight field of a media file being played of FIG. 3. In step S40, the control unit 23 determines whether a command is received from the input unit 21. If the command is not received, the procedure goes to step S36 to continually decode and play the media file being played. If any command is received, in step S41 the control unit 23 identifies the command and generates a corresponding control command to control the file management unit 22. For example, if the control command is for replaying the media file being played, in step S42, the file management unit 22 increases the weighted value in the weight field of the media file by a first predetermined value, such as 3, and the procedure goes to step S36 to continually decode and play the media file, according to the control command. If the control command is for skipping the media file being played, in step S43, the file management unit 22 obtains an amount of frames having been played and a total amount of frames the media file has.

In step S44, the file management unit 22 divides the amount of frames that have been played by the total amount of frames the media file has to obtain a percentage. The obtained percentage is capable of indicating an operation state on the media file. For example, when the obtained percentage is less than 5% that means a user is skimming the media file listed on the play-list; when the obtained percentage is more than 95% that means a user have almost listened to the entire media file. In step S45, the file management unit 22 determines a percentage range to which the obtained percentage belongs.

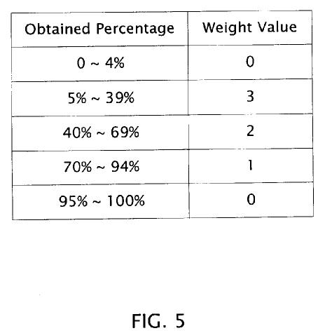

In step S46, the file management unit 22 decreases the weighted value in the weight field of the media file by a second predetermined value corresponding to the percentage range to which the obtained percentage belongs. The second predetermined values indicate the user's annoying level on a given media file. For simplicity, referring to FIG. 5, when the obtained percentage is between 0 and 4%, it does not represent that the user dislikes the media file, thereby the file management unit 22 maintains the weighted value in the weight field of the media file as the same as before being skipped; when the obtained percentage is between 5% and 39%, it represents that the user dislikes the media file most, thereby the file management unit 22 decreases the weighted value in the weight field of the media file by 3; when the obtained percentage is between 40% and 69%, it represents that the user dislikes the media file more, thereby the file management unit 22 decreases the weighted value in the weight field of the media file by 2; when the obtained percentage is between 70% and 94%, it represents that the user dislikes the media file a little, thereby the file management unit 22 decreases the weighted value in the weight field of the media file by 1; when the obtained percentage is between 95% and 100%, it represents that the user have almost listened to the entire media file, thereby the file management unit 22 maintains the weighted value in the weight field of the media file as the same as before being skipped. The percentage range and the relationship between the percentage range and the weighted value may vary. That is, the percentage range and the relationship between the percentage and the weighted value can be set and adjusted.

In step S47, the file management unit 22 skips the media file, and the procedure goes to step S35 to obtain a next media file listed on the play-list. In step S41, if the control command is for other functions, in step S48, the control unit 23 controls a corresponding unit to perform a corresponding operation according to the control command; for example, if the control unit 23 controls the file management unit 22 to stop playing the media files, and the procedure is finished.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A method for generating a play-list of media files, each of the media files comprising a tag for holding basic information about the media file, the method comprising the steps of:
setting a weight field in the tag for storing a weighted value of the media file;
receiving a control command in course of playing a media file;
increasing the weighted value in the weight field of the media file by a first predetermined value if the control command is for replaying the media file;
decreasing the weighted value in the weight field of the media file by a second predetermined value if the control command is for skipping the media file;
receiving and responding to a control command being for generating a play-list;
obtaining the weighted value in the weight field of each media file from the weight field thereof; and
generating the play-list of the media files according to the weighted values thereof.

2. The method for generating a play-list according to claim 1, wherein the step of generating the play-list of the media files further comprises: rearranging all the media files according to the weighted values, thereby generating the play-list therefrom.

3. The method for generating a play-list according to claim 1, wherein the step of generating the play-list of the media files further comprises: rearranging all the media files according to the weighted values in descending order, selecting a plurality of media files from the media file with a greatest weighted value, thereby generating the play-list therefrom.

4. The method for generating a play-list according to claim 1, wherein the step of generating the play-list of the media files further comprises: selecting a plurality of media files each of which has a weighted value being greater than a predetermined value, thereby generating the play-list therefrom.

5. The method for generating a play-list according to claim 1, wherein the step of generating the play-list of the media files further comprises: rearranging all the media files based on the weighted values in descending order, selecting a predetermined amount of media files on the top of the ordered list, thereby generating another play-list therefrom.

6. The method for generating a play-list according to claim 1, wherein the step of decreasing the weighted value in the weight field of the media file further comprises:
obtaining an amount of frames having been played and a total amount of frames the media file has;
dividing the amount of frames having been played by the total amount of frames the media file has to obtain a percentage;
determining a percentage range to which the obtained percentage belongs; and
decreasing the weighted value in the weight field of the media file by one of the second predetermined values corresponding to the percentage range to which the obtained percentage belongs.

7. The method for generating a play-list according to claim 6, wherein the first predetermined value can be adjusted.

8. The method for generating a play-list according to claim 6, wherein the second predetermined values can be adjusted, which respectively indicate the user's annoying level on a given media file.

9. The method for generating a play-list according to claim 6, wherein the amount of the percentage ranges may vary, which can be preset and adjusted.

10. The method for generating a play-list according to claim 6, wherein if the obtained percentage is less than a third predetermined value, maintaining the weighted value in the weighted value of the media file.

11. The method for generating a play-list according to claim 6, wherein if the obtained percentage is more than a fourth predetermined value, maintaining the weighted value in the weighted value of the media file.

12. A system for generating a play-list of media files, each of the media files comprising a tag for holding basic information about the media files, the system comprising:
a data storage unit for storing the media files, wherein the tag of each media file comprises a weight field for storing a weighted value thereof;
an input unit for generating commands in response to operations of a user;
a control unit for identifying the commands and performing corresponding control commands, wherein the control commands comprises a play-list generation control command; and
a file management unit, for receiving a control command in course of playing a media file, increasing the weighted value in the weight field of the media file by a first predetermined value if the control command is for replaying the media file, decreasing the weighted value in the weight field of the media file if the control command is for skipping the media file, receiving and responding to the play-list generation control command; obtaining the weighted value in the weight field of each media file from the weight field thereof; and generating the play-list of the media files according to the weighted values thereof.

13. The system for generating a play-list according to claim 12, wherein the file management unit further rearranges all the media files stored in the data storage unit according to the weighted values, thereby generating the play-list therefrom.

14. The system for generating a play-list according to claim 12, wherein the file management unit further rearranges all the media files stored in the data storage unit according to the weighted values in descending order, selecting a plurality of media files from the media file with a weighted value greater than a predetermined value, thereby generating the play-list therefrom.

15. The system for generating a play-list according to claim 12, wherein the file management unit further selects a plurality of media files each of which has a weighted value being greater than a predetermined value, thereby generating the play-list therefrom.

16. The system for generating a play-list according to claim 12, wherein the file management unit further rearranges all the media files based on the weighted values in descending order, selects a predetermined amount of media files on the top of the ordered list, thereby generates another play-list therefrom.
